(19) United States
(12) Patent Application Publication
(10) Pub. No.: US 2026/0313062 A1
(43) Pub. Date: Oct. 8, 2026

(54) READING APPARATUS, READING METHOD, AND STORAGE MEDIUM

(71) Applicant: CANON KABUSHIKI KAISHA, Tokyo (JP)

(72) Inventors: TAKAYUKI YAMADA, Kanagawa (JP); YOSHINORI MIZOGUCHI, Tokyo (JP); SHINJIRO HORI, Kanagawa (JP); YUKI ISHIDA, Kanagawa (JP); NAOKI SUMI, Kanagawa (JP); YUTO KAJIWARA, Kanagawa (JP); KAZUFUMI KONDO, Kanagawa (JP); KOSUKE SASAKI, Kanagawa (JP)

(21) Appl. No.: 19/461,950

(22) Filed: Jan. 28, 2026

(30) Foreign Application Priority Data
Feb. 12, 2025 (JP) 2025-020841

(51) Int. Cl. H04N 1/405; H04N 1/387

(52) U.S. Cl. CPC H04N 1/4052; H04N 1/3871

(57) ABSTRACT

To appropriately reduce moire, a reading apparatus includes: a reading unit configured to be capable of reading a document; a first obtaining unit configured to obtain a learned parameter which is a model parameter of a machine learning model learned with an input image of a printed product printed with a dot period as an input; a model execution unit configured to cause the machine learning model to perform a process using the learned parameter with a read image of the document obtained based on reading by the reading unit as an input; and a second obtaining unit configured to obtain a corrected image subjected to a correction process for reducing an unintended pattern that appears due to the dot period by using a result of the process executed by the model execution unit.

### BACKGROUND

### Field of the Technology

The present disclosure relates to a reading apparatus, a reading method, and storage medium.

### Description of the Related Art

As reading apparatuses, image scanners using an image sensor have been known. Reading a printed product may result in an unintended wave-like pattern appearing in the image. This pattern is called moire. In offset printing, moire may occur due to the period of the halftone dots. Also, in inkjet printing, moire may occur due to interference between the periodicity of dots resulting from the printing process and the periodicity of sampling for reading. Such moire is an unnecessary pattern that does not exist on the actual printed product, and may deteriorate the visual recognizability to the user. To address this, some image reading apparatuses perform a process to reduce the moire. In Japanese Patent Laid-Open No. 2020-69717, the halftone dot screen ruling of image data obtained by reading a printed product is judged based on the change in brightness or darkness between adjacent pixels in the image data, and image processing is performed based on the result of the judgment to reduce moire.

### SUMMARY

Here, moire patterns vary in frequency. For this reason, there are cases where moire cannot be appropriately reduced.

A reading apparatus according an aspect of the present disclosure includes: a reading unit configured to be capable of reading a document; a first obtaining unit configured to obtain a learned parameter which is a model parameter of a machine learning model learned with an input image of a printed product printed with a dot period as an input; a model execution unit configured to cause the machine learning model to perform a process using the learned parameter with a read image of the document obtained based on reading by the reading unit as an input; and a second obtaining unit configured to obtain a corrected image subjected to a correction process for reducing an unintended pattern that appears due to the dot period by using a result of the process executed by the model execution unit.

Features of the present disclosure will become apparent from the following description of embodiments with reference to the attached drawings. The following description of embodiments are described by way of example.

### BRIEF DESCRIPTION OF THE DRAWINGS

FIG. 1 is a view illustrating an example of an exterior configuration of a reading apparatus;

FIG. 2 is a diagram illustrating an example of a configuration of a reading unit;

FIG. 3 is a block diagram illustrating an example of a configuration of the reading apparatus;

FIG. 4 is a flowchart illustrating an example of image processing to be executed by an image processing unit;

FIG. 5 is a diagram illustrating an example of a machine learning model;

FIG. 6 is a diagram for describing a convolution process;

FIG. 7 is a diagram illustrating an example of a learning setting screen;

FIG. 8 is a flowchart illustrating an example of a learning process;

FIG. 9 is a flowchart illustrating an example of a training data creation process;

FIG. 10 is a diagram illustrating example images for describing the training data creation process and the like;

FIG. 11 is a flowchart illustrating an example of a moire correction process in a first embodiment;

FIG. 12 is a diagram illustrating an example of a machine learning model as another image generation model;

FIG. 13 is a diagram illustrating an example of a machine learning model as a classification model;

FIG. 14 is a diagram illustrating an example of a training data creation screen;

FIG. 15 is a flowchart illustrating an example of a training data creation process using the training data creation screen;

FIG. 16 is a flowchart illustrating an example of a moire correction process in a second embodiment;

FIG. 17 is a table listing a parameter for a coefficient for each classification label;

FIG. 18 is a flowchart illustrating an example of a moire correction process in a third embodiment;

FIG. 19 is a block diagram illustrating an example of a configuration of the reading apparatus in a case where it is a copying apparatus;

FIG. 20 is a diagram illustrating an example of a user interface (UI) screen correction modes; and

FIG. 21 is a diagram illustrating an example of a preview screen.

### DESCRIPTION OF THE EMBODIMENTS

Hereinafter, with reference to the attached drawings, the present disclosure is explained in detail in accordance with preferred embodiments. Configurations shown in the following embodiments are merely exemplary and the present disclosure is not limited to the configurations shown schematically. Incidentally, an identical reference numeral is assigned to an identical constituent and an explanation thereof is made.

### First Embodiment

### <Image Reading Apparatus>

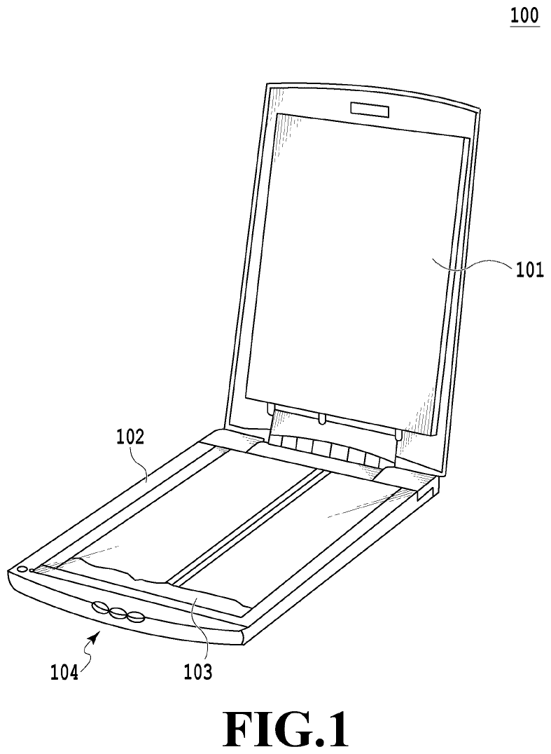

FIG. 1 is a view illustrating an example of an exterior configuration of a reading apparatus 100. The reading apparatus 100 includes a document plate cover 101, a document plate 102, a reading unit 103, and an operation part 104. The document plate cover 101 is a member that holds down a document placed on the document plate 102. The document plate 102 is a plate to place a document. The reading unit 103 is capable of reading the document placed on the document plate 102. The operation part 104 is an operation device operable by the user. In response to an operation by the user, the operation part 104 outputs information for executing an action corresponding to that operation.

In a case of reading a document with the reading apparatus 100, the user places the document on the document plate 102, holds down that document with the document plate cover 101, and then operates the operation part 104. The operation part 104 is provided with a plurality of buttons. Some of the plurality of buttons are a first read button, a second read button, and a third read button. The first read button is a button for executing a high-resolution color scan mode being a mode for performing color reading at a high resolution. The second read button is a button for executing a low-resolution color scan mode being a mode for performing color reading at a low resolution. The third read button is a button for executing a high-resolution monochrome scan mode being a mode for performing monochrome reading at a high resolution. The user presses a button corresponding to a scan mode which the user desires. In response to this press, the reading unit 103 starts reading the document.

In the high-resolution color scan mode, the reading apparatus 100 can read a document at a high resolution in color. In the low-resolution color scan mode, the reading apparatus 100 can read a document at a low resolution in color. In the high-resolution monochrome scan mode, the reading apparatus 100 can read a document at a high resolution in monochrome.

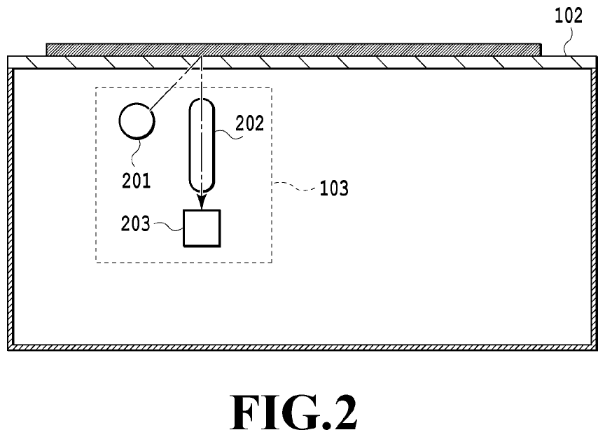

FIG. 2 is a diagram illustrating an example of a configuration of the reading unit 103. The reading unit 103 is movable in a main scanning direction and a sub scanning direction intersecting the main scanning direction. The reading unit 103 is moved by motors (not illustrated). The reading unit 103 includes a light source 201, a rod lens array 202, and a sensor 203. The reading unit 103 applies light from the light source 201 onto a document placed on the document plate 102, and light with a diffusely reflected component reflected by the document passes through the rod lens array 202. The sensor 203 detects the light having passed through the rod lens array 202 and performs photoelectrically converts the detected light. The sensor 203 outputs a signal obtained by the photoelectric conversion.

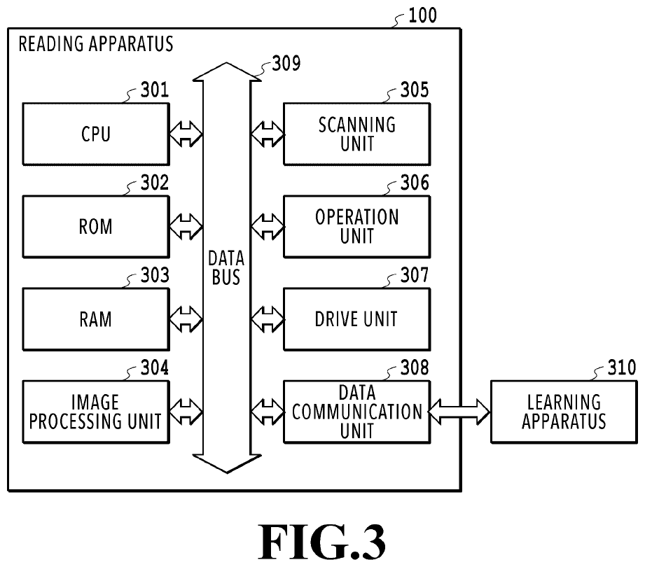

FIG. 3 is a block diagram illustrating an example of a configuration of the reading apparatus 100. The reading apparatus 100 includes a central processing unit (CPU) 301, a read-only memory (ROM) 302, a random-access memory (RAM) 303, an image processing unit 304, a scanning unit 305, an operation unit 306, a drive unit 307, a data communication unit 308, and a data bus 309.

The CPU 301 is a processing unit for implementing various functions of the reading apparatus 100. The CPU 301 includes at least one processor. The CPU 301 executes various processes by executing programs or activating hardware. The CPU 301 executes the programs by loading the programs to the RAM 303 and expanding them.

The ROM 302 stores various pieces of data. For example, the ROM 302 stores programs to be executed by the CPU 301. Also, the ROM 302 stores various values, tables, mathematical equations, and the like to be used in image processing, such as shading correction. The various values to be used in the image processing include learned parameters. The learned parameters are model parameters obtained by learning. The model parameters are parameters to be used by machine learning models.

The RAM 303 is used as a work memory for the CPU 301 and the like. For example, the RAM 303 temporarily stores various pieces of information in a case where the CPU 301 executes programs or in a case where the image processing unit 304 performs image processing.

The image processing unit 304 performs image processing such as correction of image data generated by the scanning unit 305 or image encoding. The image data correction includes shading correction and gamma correction.

The scanning unit 305 obtains the signal output from the reading unit 103. This signal includes, for example, values indicating red (R), green (G), and blue (B) analog luminances. The scanning unit 305 executes an analog-to-digital (AD) conversion process on the obtained signal based on the scan mode designated by the user, and generates image data corresponding to the scan mode.

The operation unit 306 monitors each of the plurality of buttons included in the operation part 104 (FIG. 1). In response to detecting any of the plurality of buttons, the operation unit 306 outputs information corresponding to the detected button. For example, in response to detecting a press on any of the first read button, the second read button, and the third read button, the operation unit 306 outputs an instruction to perform reading in the scan mode corresponding to the detected button.

The drive unit 307 is a unit that causes the reading unit 103 to operate. The drive unit 307 includes, for example, a driver circuit and the like for controlling the motors that drive the reading unit 103.

The data communication unit 308 is an interface that receives and outputs data from and to one or more external devices. One of the external devices is a learning apparatus 310. The learning apparatus 310 is an apparatus that causes a machine learning model to execute processes. The learning apparatus 310 has hardware, such as a CPU, a graphics processing unit (GPU), an application-specific integrated chip (ASIC), and a field-programmable gate array (FPGA), capable of executing learning processes. Examples of the learning apparatus 310 include a personal computer, a server, a smartphone, a printer, and the like.

the data bus 309 communicably connects blocks to one another. The blocks include the CPU 301, the ROM 302, the RAM 303, the image processing unit 304, the scanning unit 305, the operation unit 306, the drive unit 307, and the data communication unit 308.

Note that the reading apparatus 100 includes the image processing unit 304 in the example of FIG. 3, but may not include the image processing unit 304. In a case where the image processing unit 304 does not include the reading apparatus 100, the CPU 301, for example, performs the image processing to be executed by the image processing unit 304. Alternatively, an information processing apparatus connected through the data communication unit 308 may perform the image processing to be executed by the image processing unit 304. This information processing apparatus may be a personal computer. Alternatively, the information processing apparatus may be a server that provides a service.

Also, in the present embodiment, the reading apparatus 100 is a flatbed reading apparatus, but may be a sheet-fed reading apparatus. In the case of a flatbed reading apparatus, the reading unit 103 moves relative to a fixed document. In the case of a sheet-fed reading apparatus, a document is moved related to a fixed reading unit. In this case, the document is moved by an automatic document feeder (ADF).

### <Image Processing>

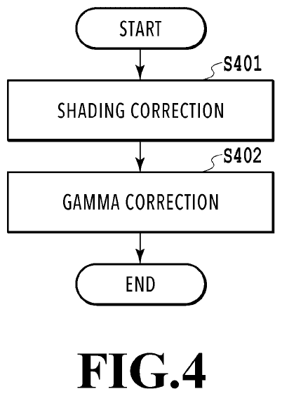

FIG. 4 is a flowchart illustrating an example of the image processing to be executed by the image processing unit 304. The flowchart of FIG. 4 is executed each time the operation unit 306 detects a press on any of the buttons corresponding respectively to the plurality of scan modes. Note that each symbol “S” in the following description of the flowchart means a step.

In S401, the image processing unit 304 performs shading correction on image data generated by the scanning unit 305. The shading correction corrects variation of the image capturing element (sensor 203). For example, in the shading correction, correction data for correcting uneven lighting or lens characteristics is generated based on white reference data and black reference data prepared in advance. The image data is corrected using this correction data to adjust unevenness in the brightness of the image in the image data. After the shading correction is performed, the processing proceeds to S402.

In S402, the image processing unit 304 performs gamma correction on the image data subjected to the shading correction. The gamma correction corrects the luminance values of the image so that the rendered image appears natural to the human eye. For example, in the gamma correction, the image data subjected to the shading correction is corrected using a gamma value table held in advance in the ROM 302 to adjust the brightness of the whole image in the image data.

### <Machine Learning>

Next, machine learning for reducing moire will be described. The machine learning involves a learning process and an estimation process. The learning process is a process of learning model parameters of a machine learning model. The estimation process is a process of causing the machine learning model to execute a process using the learned parameters. In the present embodiment, an image generation model is used as the machine learning model. The image generation model is a machine learning model that outputs images.

### <<Machine Learning Model>>

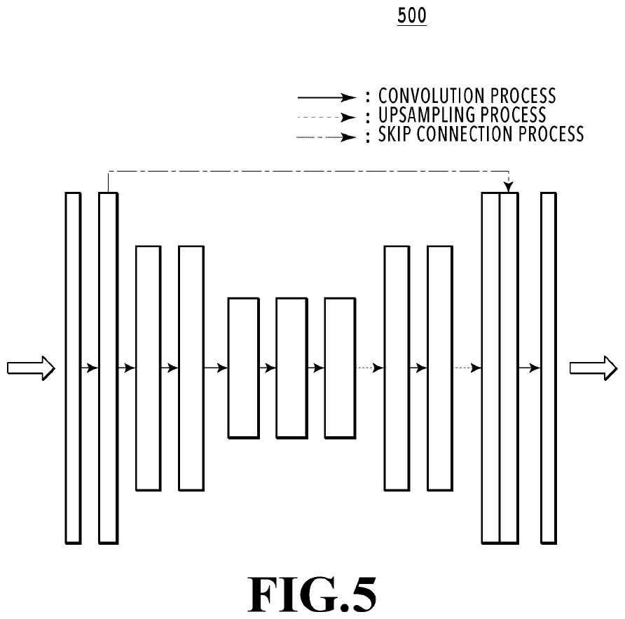

FIG. 5 is a diagram illustrating an example of a machine learning model 500. The machine learning model 500 is an image generation model. Moreover, the machine learning model 500 is a machine learning model based on a convolutional neural network (CNN model).

In the example of FIG. 5, each rectangle represents image data. The length of this rectangle in the vertical direction represents the number of pixels in the image data. The larger the number of pixels, the longer the vertical length of the rectangle representing the image data. The length of the rectangle in the horizontal direction represents the number of channels in the image data. The larger the number of channels, the longer the horizontal length of the rectangle representing the image data.

Also, in the example of FIG. 5, each arrow represents a process. Specifically, each solid arrow represents a convolution process. Each dashed arrow represents an upsampling process. The long dashed short dashed arrow represents a skip connection process. The convolution process includes a calculation that moves a filter over the image to derive the sum of products between the portion of the image on which the filter is placed and the filter. Details of this convolution process will be described later. The upsampling process is a process that increases the number of pixels of the image data. In the present embodiment, the upsampling process is executed using bilinear interpolation but is not limited to this. For example, the upsampling process may be executed using different interpolation such as nearest interpolation or bicubic interpolation. Alternatively, the upsampling process may be executed using deconvolution. The skip connection process is a process that connects the output of a layer to a later layer. Specifically, it connects the image data before upsampling processes and the image data after the upsampling processes in the channel direction.

Image data with three channels, namely R, G and B channels, for example, is input into the machine learning model 500. In response to the input of the image data, the machine learning model 500 starts processing. Specifically, the input image data is subjected to a first convolution process. Then, the image data obtained by the first convolution process is subjected to a second convolution process involving downsampling. Then, the image data obtained by the second convolution process is subjected to a third convolution process. Then, the image data obtained by the third convolution process is subjected to a fourth convolution process involving downsampling. Then, the image data obtained by the fourth convolution process is subjected to a fifth convolution process and a sixth convolution process in this order. Then, the image data obtained by the sixth convolution process is subjected to an upsampling process. Then, the image data obtained by the upsampling process is subjected to a seventh convolution process. Then, the image data obtained by the seventh convolution process is subjected to an upsampling process. Then, the image data obtained by the upsampling process is subjected to a skip connection process. In the example of FIG. 5, the image data obtained by the first convolution process is connected to the image data obtained by the upsampling process. Then, the image data obtained by the skip connection process is subjected to an eighth convolution process. This image data obtained by the eighth convolution process is output as the result of the processing by the machine learning model 500.

As described above, the structure of the machine learning model 500 has eight convolution process layers, two upsamplings, and one skip connection, but may be a different structure. For example, at least one of the number of layers and the number of channels may be increased. While increasing at least one of the number of layers and the number of channels increases the processing load, it is expected to improve accuracy.

### <<Convolution Process

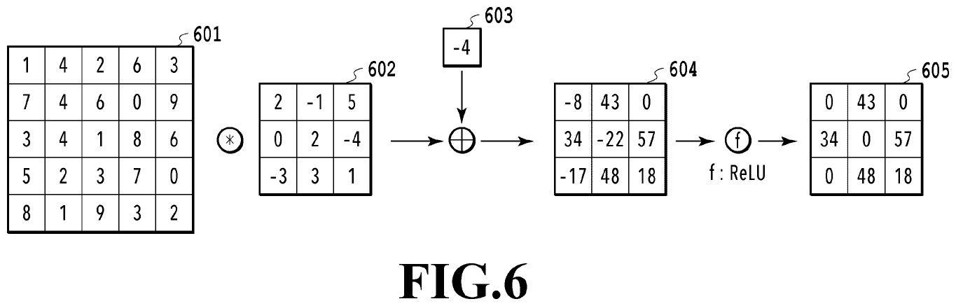

FIG. 6 is a diagram for describing a convolution process. In a convolution process, first, a convolution calculation is performed with input data 601 and weight 602. Then, a bias 603 is added to the result of this convolution calculation to obtain intermediate data 604. Then, the intermediate data 604 is converted by an activation function f to obtain output data 605. The activation function f is the rectified linear unit (ReLU), but an activation function other than ReLU may be used instead. In a case where the activation function f is ReLU, all values less than 0 will be 0 in the output data 605. Note that the weight 602 and the bias 603 are model parameters, are learned in the learning process. The weight 602 is also called a filter or a window.

In the example of FIG. 6, the numbers of channels in the input data 601, the intermediate data 604, and the output data 605 are all one but are not limited to this. Also, the size of the weight 602 is 3×3 but is not limited to this. For example, in a case where the number of channels in the input data 601 is M, the number of channels in the intermediate data 604 is N, and the size of the weight 602 is K×K, the weight 602 is a (K×K×M×N)-dimensional matrix. In this case, the bias 603 is an N-dimensional vector.

Also, in the example of FIG. 6, the sizes of the input data 601 and the intermediate data 604 are different but can be made equal. For example, the sizes of the input data 601 and the intermediate data 604 will be equal by performing a padding process on the input data 601 and performing a convolution calculation with the result of that padding process and the weight 602. The padding process is a process that adds pixels with a value 0 or the like around the input data 601.

Also, in the example of FIG. 6, the stride in the convolution process is 1, but may be other than 1. Note that the stride is the width across which the filter (weight 602) is moved. For example, in a case where the stride is 2, the input data 601 is subjected to a convolution calculation with the weight 602 at every other pixel. In this case, the number of pixels of the intermediate data 604 will be ¼ of the number of pixels of the input data 601. This makes it possible to implement the convolution processes involving downsampling, each of which is one of the processes by the machine learning model 500 described above. Note that the downsampling does not need to a convolution process. For example, it may be downsampling by max pooling.

### <<Learning Setting Screen>>

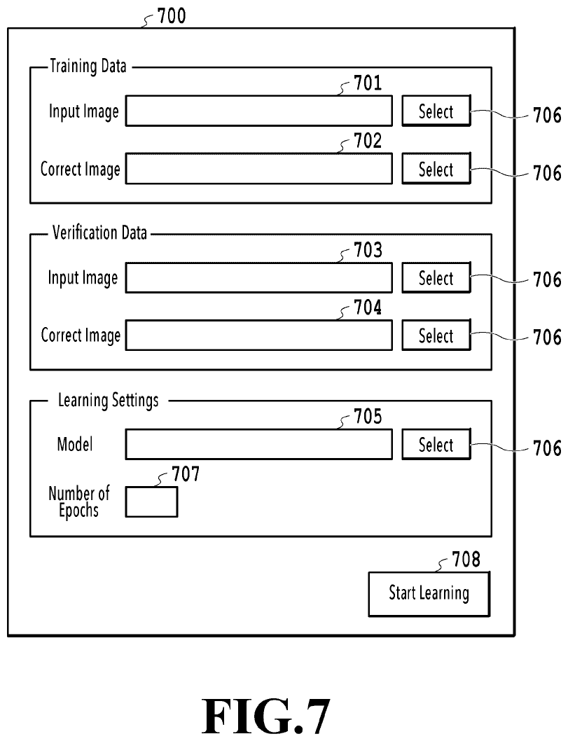

FIG. 7 is a diagram illustrating an example of a learning setting screen 700. The learning setting screen 700 is a setting screen for a learning process. This learning setting screen 700 is displayed by the learning apparatus 310.

For example, in response to receiving an instruction to launch an executable file, the learning apparatus 310 displays the learning setting screen 700, which is a user interface, on a display included in the learning apparatus 310. The executable file is stored in a storage device accessible by the learning apparatus 310. Note that the executable file is not limited to one which directly displays the learning setting screen 700 in response to being launched. For example, an executable file may be employed which displays a launcher screen in response to being launched, and displays the learning setting screen 700 in a case where an item for configuring learning settings provided in that launcher screen is selected.

The learning setting screen 700 is provided with a plurality of text boxes. In each text box, a folder path to a folder stored in a storage device accessible by the learning apparatus 310 is set.

A first text box 701 is a text box for setting a path to a folder storing input images to be used for the learning. A second text box 702 is a text box for setting a path to a folder storing correct images to be used for the learning. A third text box 703 is a text box for setting a path to a folder storing training images to be used for accuracy verification in the learning. A fourth text box 704 is a text box for setting a path to a folder storing correct images to be used for the accuracy verification in the learning. By using verification data besides training data, it is possible to obtain model parameters that do not overfit to the training data and have good generalization performance (learned parameter). A fifth text box 705 is a text box for setting a path to a folder for a model structure to be used for the learning. A model structure indicates the structure of a machine learning model. That is, a model structure is information indicating a structure defining a machine learning model. For example, a model structure indicates the types, number, and the like of layers. The model structure is saved in a text format as structured data in the folder. In the folder, pieces of structured data corresponding to a plurality of machine learning models including the machine learning model 500 are saved.

Also, the learning setting screen 700 is provided with select buttons 706 respectively for the plurality of text boxes. In a case where the user presses a select button 706, a selection dialogue is displayed on the display, and the user selects (designates) a folder in the selection dialogue, in response to which the folder path to that folder is set in the text box.

Also, the learning setting screen 700 is provided with a numerical value box 707 and a learning start button 708. The numerical value box 707 is a text box for setting the number of epochs for the learning. The learning start button 708 is a button for starting the learning process. In response to a press on the learning start button 708, the learning apparatus executes the learning process based on the contents of the settings set on the learning setting screen 700.

### <<Learning Process>

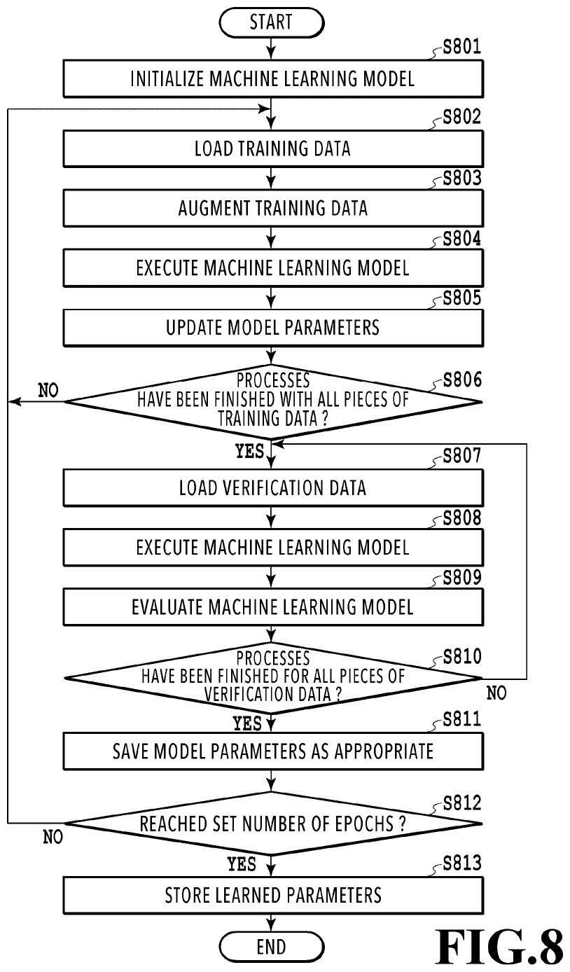

FIG. 8 is a flowchart illustrating an example of a learning process. The symbol “S” in the following description of the flowchart represents a step. The learning apparatus 310 implements the series of processes illustrated in the flowchart of FIG. 8 (learning process) by executing a program. The learning process starts in a case where the learning apparatus 310 accepts an instruction to start learning. The instruction to start learning is supplied to the learning apparatus 310 in response to a press on the learning start button 708.

In S801, the learning apparatus 310 initializes a machine learning model. Specifically, the learning apparatus 310 loads structured data from the folder path set in the fifth text box 705, and recognizes the machine learning model corresponding to that structured data as the machine learning model to be executed. Also, the learning apparatus 310 sets initial values of the model parameters to be used for the machine learning model to be executed. After the machine learning model is initialized, the process proceeds to S802.

Note that the initial values of the model parameters may be random values generated by a random number generator. Alternatively, the initial values of the model parameters may be values generated by an initialization algorithm, such as Xavier initialization or He initialization. Alternatively, the initial values of the model parameters may be values learned in advance using large datasets for other tasks such as image recognition.

In S802, the learning apparatus 310 loads a piece of training data. In the present embodiment, the learning apparatus 310 loads the training data from the folder paths set in the first text box 701 and the second text box 702. That is, the training data includes a training pair being a pair of an input image and a correct image. After the training data is loaded, the process proceeds to S803.

Note that the input image is an image containing moire. The input image is also called a sample image or a training image. The correct image is an image in which the moire has been reduced. A plurality of training pairs are stored in a storage device accessible by the learning apparatus 310. The method of managing the training pairs is not particularly limited. For example, the images forming each training pair are managed are managed with the same file name. Alternatively, the images forming each training pair are managed with file names each having a prefix indicating an input image or a correct image. Alternatively, the images forming each training pair are recorded and managed in table data.

In S803, the learning apparatus 310 is performs augmentation of the training data loaded in S802. The augmentation of the training data is a process that generates various pieces of training data from one piece of training data by processing the piece of training data. After the augmentation of the training data is performed, the process proceeds to S804.

Note that examples of the processing of the training data include inversion, rotation, trimming, and the like. Also, the augmentation of the training data does not necessarily need to be performed during the learning process. The augmentation of the training data may be performed in advance before the learning process. In this case, the process of S803 is not executed.

In S804, the learning apparatus 310 causes the machine learning model corresponding to the structured data loaded in S801 to execute a process with the input image in the training data as an input, and obtains the result of that process as an output image. After the output image is obtained, the process proceeds to S805.

In S805, the learning apparatus 310 updates the model parameters. For example, the learning apparatus 310 updates the model parameters in such a way as to minimize the error between the output image obtained in S804 and the correct image paired with the input image input into the machine learning model in S804. In this case, the mean squared error, for example, is used as a function for calculating the error (loss function). Further, a gradient is calculated using error back propagation to update the model parameters. Note that the mean absolute error, perceptual similarity, or the like may be used as the loss function. After the model parameters are updated, the process proceeds to S806.

In S806, the learning apparatus 310 judges whether the processes of S802 to S805 (primary process) have been finished with all pieces of training data stored in the folders. The learning apparatus 310 returns to S802 if judging in S806 that the primary process has not been finished, and proceeds to S807 if judging that the primary process has been finished.

In S807, the learning apparatus 310 loads a piece of verification data. In the present embodiment, the learning apparatus 310 loads the verification data from the folder paths set in the third text box 703 and the fourth text box 704. That is, the verification data in the present embodiment includes a verification pair being a pair of an input image and a correct image. After the verification data is loaded, the process proceeds to S808.

Note that a plurality of verification pairs are stored in a storage device accessible by the learning apparatus 310. The input image included in the verification data is different from the input image included in the training data. Similarly, the correct image included in the verification data is different from the correct image included in the training data. Using images that are not included in the training data for the verification data makes it possible to verify whether the machine learning model does not overfit to the training data and has appropriate generalization performance.

In S808, the learning apparatus 310 causes the machine learning model corresponding to the structured data loaded in S801 to execute a process with the input image in the verification data as an input, and obtains the output image output from the machine learning model as the result of that process. After the output image is obtained, the process proceeds to S809.

In S809, the learning apparatus 310 evaluates the accuracy of the machine learning model. For example, the learning apparatus 310 calculates an evaluation value using the output image obtained in S808 and the correct image paired with the input image input into the machine learning model in S808. In the present embodiment, the sum of the peak signal-to-noise ratio (PSNR) indicating the difference from the original pixels and the learned perceptual image patch similarity (LPIPS) indicating perceptual similarity between the images is calculated as the evaluation value. Note that an image quality evaluation index such as the structural similarity index measure (SSIM) may be calculated as the evaluation value. Alternatively, the value of the least square error between the estimated image and the correct image may be calculated as the evaluation value. After the accuracy of the machine learning model is evaluated, the process proceeds to S810.

In S810, the learning apparatus 310 judges whether the processes of S807 to S809 (secondary process) have been finished for all pieces of verification data stored in the folders. The learning apparatus 310 returns to S807 if judging in S810 that the secondary process has not been finished, and proceeds to S811 if judging that the secondary process has been finished.

In S811, the learning apparatus 310 saves the updated model parameters as appropriate. First, the learning apparatus 310 associates the current model parameters and the evaluation value calculated in S809 with each other. Then, if the evaluation value is higher than the highest evaluation value in the learning process, the learning apparatus 310 saves the model parameters and the evaluation value to a storage device and updates the highest evaluation value with the current evaluation value. Thereafter, the process proceeds to S812. Note that the initial value of the highest evaluation value is 0. Thus, the model parameters and the evaluation value are saved to the storage device without fail.

In S812, the learning apparatus 310 confirms whether the current number of repetitions of learning has reached the number of epochs set in the numerical value box 707. The number of repetitions of learning is incremented in a case where it is confirmed that the secondary process has been finished, for example. If the current number of repetitions of learning has not reached the number of epochs, the process returns to S802. If the current number of repetitions of learning has reached the number of epochs, the process proceeds to S813.

In S813, the learning apparatus 310 controls the ROM 302, which is a storage unit of the reading apparatus 100, such that it stores the model parameters saved in the storage device as learned parameters. After the learned parameters are stored, the series of processes illustrated in the flowchart of FIG. 8, or the learning process, is terminated.

Note that, in the above learning process, the learned parameters are stored in a case where the number of repetitions of learning reaches the number of epochs, but the learning process is not limited to this. For example, in a case where the highest evaluation value does not get updated in S811 a certain number of times in a row, the learning apparatus 310 may consider that the optimization process has reached convergence, control the ROM 302 such that it stores the learned parameters, and then terminate the learning process

### <<Training Data Creation Process>

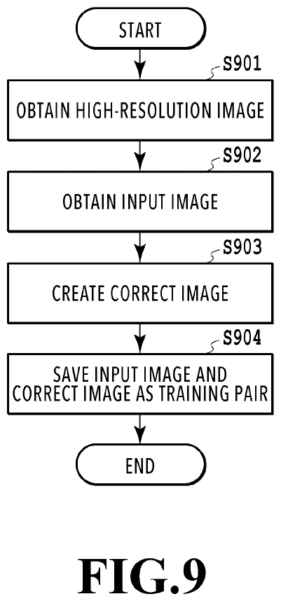

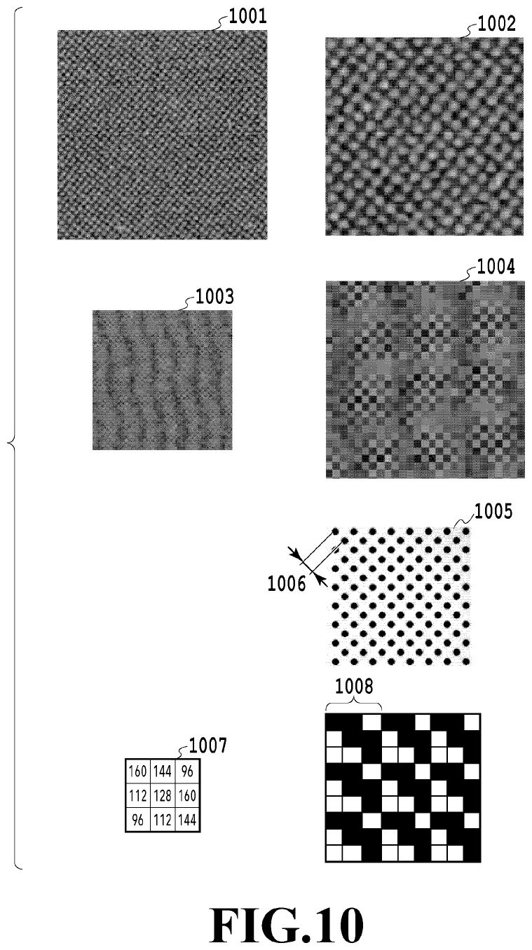

FIG. 9 is a flowchart illustrating an example of a training data creation process. The learning apparatus 310 executes the series of processes illustrated in the flowchart of FIG. 9 (training data creation process). For example, in response to a press on a button included in the learning apparatus 310, the learning apparatus 310 accepts an instruction to create training data and starts a training data creation process. FIG. 10 is a diagram illustrating example images for describing the training data creation process and the like. In the example of FIG. 10, a printed product printed by offset printing is read. A method of creating training data will be described below using FIGS. 9 and 10. In S901, the learning apparatus 310 obtains a high-resolution image.

Specifically, the learning apparatus 310 requests the reading apparatus 100 to perform high-resolution reading. In response to receiving the high-resolution reading request from the learning apparatus 310, the reading apparatus 100 generates a high-resolution image and transmits it to the learning apparatus 310. The learning apparatus 310 obtains the high-resolution image transmitted as a response to the reading request from the reading apparatus 100. After the high-resolution image is obtained, the process proceeds to S902.

Note that the high-resolution image is image data obtained by reading the printed product placed on the document plate 102 into high-resolution image data and performing the image processing illustrated in FIG. 4 on that image data. A patch 1001 is a portion cut out from the obtained high-resolution image. The resolution of the patch 1001 is 1200 dpi. It can be seen that dots are arranged in a regular pattern in a patch 1002, which is an enlarged portion of the patch 1001.

In S902, the learning apparatus 310 obtains an input image to be used in a learning process. Specifically, the learning apparatus 310 requests the reading apparatus 100 to perform low-resolution reading. In response to receiving the low-resolution reading request from the learning apparatus 310, the reading apparatus 100 generates a low-resolution image and transmits it to the learning apparatus 310. The learning apparatus 310 obtains the low-resolution image transmitted as a response to the reading request from the reading apparatus 100 as an input image to be used in a learning process. After the input image is obtained, the process proceeds to S903.

Note that the input image is image data obtained by reading the printed product placed on the document plate 102 into low-resolution image data and performing the image processing illustrated in FIG. 4 on that image data. A patch 1003 is a portion cut out from the obtained input image. The patch 1003 is read from the same printed product as that of the patch 1001, and the resolution of the patch 1003 is 300 dpi. While no moire pattern is present in the patch 1001, a wavy moire pattern is present in the patch 1003. It can be seen that, in a patch 1004, which is an enlarged portion of the patch 1003, the wavy moire pattern in the patch 1003 is formed by lattice-shaped variations in brightness and darkness.

In S903, the learning apparatus 310 crates a correct image to be used in a learning process from the high-resolution image obtained in S901. For example, the learning apparatus 310 performs a discrete Fourier transform process on the high-resolution image, performs a low-pass filtering process on the obtained frequency component, and performs an inverse discrete Fourier transform process on the obtained low-frequency component. This lowers the resolution and thus reduces the moire. After the correct image is created, the process proceeds to S904.

Note that, in a case where the dot period in a 1200-dpi image is 6 pixels, moire will be present in a 300-dpi image if the dot period therein is 1.5 pixels. This means that no moire will be present if the dot period on the printed product to be read is 2 pixels or less in the correct image.

In S904, the learning apparatus 310 stores the input image obtained in S902 and the correct image obtained in S903 as a training pair in a storage location designated in advance. This storage location is a storage device accessible by the learning apparatus 310. After the training pair is stored, the series of processes illustrated in the flowchart of FIG. 9, or the training data creation process, is terminated.

The user can perform an operation to execute the training data creation process each time the user places a printed product on the document plate 102 from among a plurality of printed products. By doing so, a plurality of training pairs can be stored in the storage device. Note that verification data can be created by performing a creation process in a similar manner to that described above.

Note that the training data creation process is not limited to the process described in the flowchart of FIG. 9. For example, in S903, a correct image may be created by performing a blur filtering process on the input image obtained in S902. This eliminates the need to perform the high-resolution reading, which reduces the processing load. Alternatively, in S902, an input image may be created from the high-resolution image obtained in S901. For example, instead of performing the low-pass processing in S903, the low-resolution reading of the reading apparatus 100 may be simulated. This can create an input image without having the reading apparatus 100 actually execute the low-resolution reading. Accordingly, the processing load is reduced.

Also, in the present embodiment, 1200 dpi and 300 dpi are used as the resolution of the high-resolution reading and the resolution of the low-resolution reading, respectively, but the resolutions are not limited to these. It suffices that the high resolution is a resolution with which no moire occurs, and the low resolution corresponds to the resolution with which the moire correction process to be described later is performed.

### <<Dot Period>>

The dot period will now be described using a halftone dot pattern 1005, a dither mask 1007, and a quantized image 1008 in FIG. 10, which were not used in the description of FIG. 9.

The dot period, which refers to the period at which dots are formed, includes the printing resolution of the printing apparatus that printed the document. For example, the screen ruling in offset printing or electrophotographic printing, the nozzle intervals in inkjet printing, and the like correspond to the printing resolution. Specifically, for the halftone dot pattern 1005 indicating the period between halftone dots in offset printing, a dot interval 1006 is the dot period.

Also, the dot period includes quantized patterns. For example, a repetitive pattern generated with a filter mask used for dithering for expressing area-coverage tones (dither mask) or the like corresponds to a quantized pattern. Specifically, a quantized pattern appears in the quantized image 1008, obtained by applying the dither mask 1007 having a different threshold value in each of its pixels to an image uniformly having a pixel value of 128, thereby converting the image density into area-coverage tones. Specifically, in this dithering process, a dot will be printed on the pixels in the dither mask 1007 having a pixel value above a threshold value. On the other hand, no dot will be printed on the pixels in the dither mask 1007 having a pixel value under the threshold value. The size of the dither mask 1007 is 3×3, so that a quantized pattern appears with a period of 3 pixels in the quantized image 1008.

In a case where a printed product printed with the dot period is read at a low resolution, moire may appear in the read image due to that dot period. Moire appears ideally in a case where the dot period is two times the reading period or less. That is, moire may appear in a case where the dot period in an image with a given resolution is 2 pixels or less. However, a factor such as that the sampling for reading corresponds to an aggregation over a given area, that dots of the printed product are shifted, or that dots of the printed product vary in size or in brightness and darkness makes it difficult to accurately specify the actual conditions under which moire occur. For this reason, in the present embodiment, the model parameters of a machine learning model are learned by the above-described learning process, and the learned parameters are stored in the ROM 302, which is a storage unit.

### <Moire Correction Process>

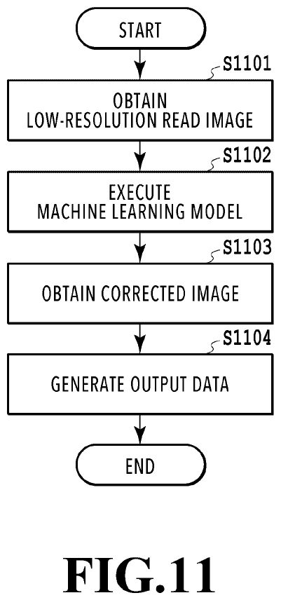

FIG. 11 is a flowchart illustrating an example of a moire correction process in the present embodiment. The CPU 301 implements the series of processes illustrated in the flowchart of FIG. 11 (moire correction process) by loading a program stored in the ROM 302 to the RAM 303 and executing it. The moire correction process starts in response to a press on the button for executing the low-resolution color scan mode (second read button). Note that the moire correction process does not start in response to a press on the button for executing the high-resolution color scan mode (first read button). Also, the moire correction process does not start in response to a press on the button for executing the high-resolution monochrome scan mode (third read button). This is because no moire appears in an image read at high resolution. Note that, depending on the value of the high resolution, the moire correction process may start in response to a press on the first read button or the third read button.

In S1101, the CPU 301 obtains a read image of a document placed on the document plate 102. Specifically, the CPU 301 controls the drive unit 307 to cause the reading unit 103 to read the document placed on the document plate 102. Then, the CPU 301 controls the scanning unit 305 to generate image data corresponding to the low-resolution color scan mode based on a signal output from the reading unit 103. Then, the CPU 301 controls the image processing unit 304 to cause the image processing unit 304 to execute the image processing illustrated in FIG. 4. The image data subjected to this image processing is the read image of the document. The resolution of the read image is a low resolution, and moire may appear in the read image. After the read image of the document is obtained, the process proceeds to S1102.

In S1102, the CPU 301 causes a machine learning model to execute a process. Specifically, the CPU 301 transmits the learned parameters stored in the ROM 302 and the read image obtained in S1101 to the learning apparatus 310 along with a model execution request. Thereafter, the process proceeds to S1103.

The model execution request is a request to cause the machine learning model to execute a process with the read image as an input by using the learned parameters. In response to accepting this model execution request, the learning apparatus 310 causes the machine learning model to execute a process with the read image as an input by using the learned parameters. The machine learning model outputs an image as the result of this process, and the learning apparatus 310 transmits that image as a response to the model execution request to the reading apparatus 100.

In S1103, the CPU 301 obtains a corrected image. Specifically, the CPU 301 obtains the image transmitted as a response to the model execution request from the learning apparatus 310. In this image, the moire has been reduced. That is, in the present embodiment, the process by the machine learning model is a correction process for reducing the moire. The CPU 301 obtains the image transmitted as the result of the process by the machine learning model from the learning apparatus 310 as a corrected image. After receiving the image transmitted from the learning apparatus 310, the CPU 301 advances the process to S1104.

In S1104, the CPU 301 generates output data. For example, the CPU 301 converts the file format of the image obtained in S1103. The file format may be a preset format or designated based on the user's operation on the operation part 104. Examples of the file format file include bitmap, Joint Photographic Experts Group (JPEG), Portable Network Graphics (PNG), and the like. After the output data being the data of the image subjected to the file format conversion is obtained, the series of processes illustrated in the flowchart of FIG. 11, or the moire correction process, is terminated.

As described above, according to the present embodiment, it is possible to appropriately reduce moire even in a case where the printing resolution, the quantization algorithm, and the like are different. For example, the reading apparatus 100 includes the ROM 302 as a storage unit storing learned parameters. The reading apparatus 100 causes a machine learning model to execute a process with a read image of a document obtained based on reading by the reading unit 103 as an input by using the learned parameters. The reading apparatus 100 obtains an image output as the result of this process from the machine learning model as a corrected image subjected to a correction process for reducing an unintended pattern that appears due to the dot period. In this way, an image being the read image of the document with reduced moire can be obtained based on the regularity between input images and moire learned by machine learning. Accordingly, it is possible to appropriately reduce moire even in a case where the printing resolution, the quantization algorithm, and the like are different.

Note that in the present embodiment, there is only one reading resolution mode for which the moire correction process is executed, but the reading resolution mode can be selected from among a plurality of reading resolutions. In that case, a learning process is performed for each of the plurality of reading resolutions, and the sets of learned parameters corresponding to the respective reading resolutions are stored in the ROM 302. The reading apparatus 100 causes a machine learning model to execute a process using the learned parameters corresponding to a selected reading resolution. In this way, a high moire correction effect can be achieved.

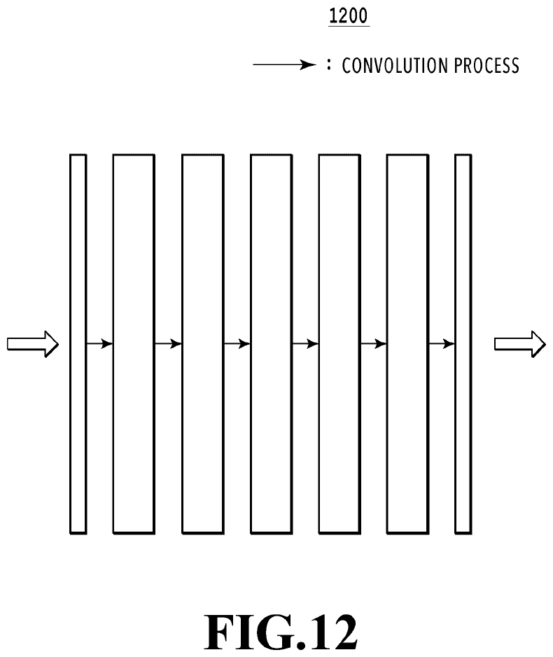

Also, in the present embodiment, the machine learning model 500 is used as one image generation model, but the image generation model is not limited to the machine learning model 500. FIG. 12 is a diagram illustrating an example of a machine learning model 1200 as another image generation model. This machine learning model 1200 is also a CNN model. The machine learning model 1200 includes neither an upsampling process nor a skip connection process and is formed of six convolution process layers. This machine learning model 1200 may be used as one CNN model in place of the machine learning model 500 or in addition to the machine learning model 500.

In a CNN model, the range that can be referenced for a target pixel is determined by the size of the convolution process, the number of layers, and the scaling process. For example, in a case where the resolution is high and the range where moire occurs is limited, using a simple CNN model, such as the machine learning model 1200, allows for high-speed processing. Also, neutral networks other than CNNs, such as transformers or fully connected networks, may also be used as machine learning models. Even in a case where moire with a very low frequency occurs, such a machine learning model can reduce the moire.

Also, in the present embodiment, the learning process is performed to make the output image close to the correct image, but is not limited to this. For example, the learning process [may be performed to make the input image close to the correct image. This reduces patterns in the output image, allowing for moire correction with less model parameters. Also, in the present embodiment, neither the training data nor the corrected data is classified by printing resolution, quantized pattern, or the like but may be classified by printing resolution, quantized pattern, or the like. This allows for effective moire reduction according to the printing resolution, the quantized pattern, or the like.

### Second Embodiment

In the first embodiment, a case in which an image generation model is used as a machine learning model has been exemplarily described. In a second embodiment, a case in which a classification model is used as a machine learning model will be exemplarily described. In the following, description of contents common to the first embodiment will be omitted as appropriate, and the difference will be mainly described.

### <Machine Learning>

In the present embodiment, a classification model is used. The classification model is a machine learning model that outputs the probabilities of classification labels.

### <<Machine Learning Model>>

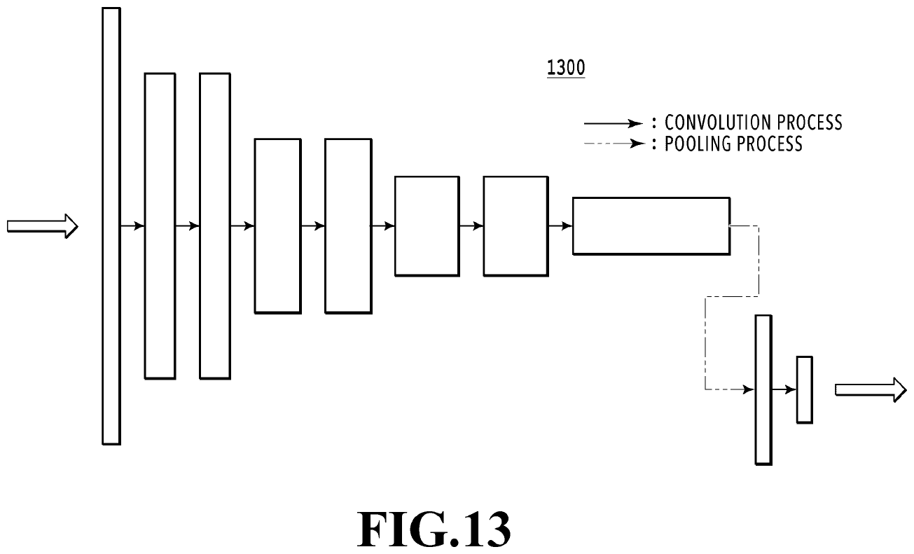

FIG. 13 is a diagram illustrating an example of a machine learning model 1300 as a classification model. In the example of FIG. 13, image data is illustrated similarly to the example of FIG. 5. Also, in the example of FIG. 13, each solid arrow represents a convolution process, as in the example of FIG. 5. Also, the long dashed double-short dashed arrow represents a pooling process. The pooling process is performed to extract features. Specifically, it is a process that calculates the largest value or an average value for each of a plurality of regions in input data, and obtains data to be output from the calculation result. In a case of calculating the largest value, the pooling process is also called max pooling, for example. In a case of calculating an average value, the pooling process is also called average pooling, for example.

The data output from the machine learning model 1300 is data indicating the result of classification of factors causing moire. This data is obtained as the result of the pooling process, and is a one-dimensional vector with the same length as the number of channels in the data immediately before the pooling process.

The present embodiment involves classification by printing method and classification by dot period. The printing method is classified into two methods, namely amplitude modulation (AM) screening and frequency modulation (FM) screening. The AM screening method is a printing method in which the dot interval is constant and density is controlled with the dot size. The FM screening method is a printing method in which the dot size is constant, and density is controlled with the dot density. In the AM screening method, the dot period is classified into three types, namely low resolution (under 90 lpi), middle resolution (90 to 150 lpi), and high resolution (above 150 lpi). Also, the dot period is classified into four types as quantized patterns. Specifically, in the FM screening method, the dot period is classified into four types, namely high frequency (above 4 dpi), middle frequency (4 to 2 dpi), low frequency (under 2 dpi), and non-periodic.

The period here means a size with which dithering is performed. For example, in a case of performing quantization with a dither mask having 256×256 pixels at 600 dpi, the period is approximately 2.3 dpi, which corresponds to a middle period. Also, “non-periodic” represents a case where the quantization is not periodic, like error diffusion.

The machine learning model 1300 outputs seven-dimensional data corresponding to each of the above seven classifications. Specifically, each of the elements forming the seven dimensions has a value ranging from 0 to 1, and an output result in which the total of these is 1 is obtained. This output result is obtained by the softmax function or the like.

### <<Learning Process>>

In the present embodiment, the learning process illustrated in the flowchart of FIG. 8 is executed, but the data used in the learning process is different from that in the first embodiment. Specifically, in the first embodiment, the training data loaded in S802 includes a training pair including an input image and a correct image. In the present embodiment, on the other hand, the training data loaded in S802 includes a training pair including an input image and a classification label. The classification label is information indicating to which classification the input image belongs. Note that, in the present embodiment, the correct image in the first embodiment is replaced with the classification label, and thus the second text box 702 for the training data illustrated in FIG. 7 is changed as well. Specifically, in the present embodiment, the second text box 702 is a text box for setting a path to a folder storing classification labels to be used in the learning.

Also, in the first embodiment, the result of the process executed by the machine learning model in S804 or S808 is an output image. In the present embodiment, on the other hand, the result of the process executed by the machine learning model in S804 or S808 is a probability. Specifically, the probability of one of the elements forming the above-described dimensions is obtained as the result of the process executed by the machine learning model.

Also, in the first embodiment, the mean squared error is used as the loss function for the process of S805. In the present embodiment, on the other hand, a cross-entropy function is used as the loss function for the process of S805. Cross-entropy functions tend to be used for classification models.

Also, in the first embodiment, the verification data loaded in S807 includes a verification pair including an input image and a correct image. In the present embodiment, on the other hand, the verification data loaded in S807 includes a verification pair including an input image and a classification label. Note that, in the present embodiment, the correct image in the first embodiment is replaced with the classification label, and thus the fourth text box 704 for the verification data illustrated in FIG. 7 is changed as well. Specifically, in the present embodiment, the fourth text box 704 is a text box for setting a path to a folder storing classification labels to be used for accuracy verification in the learning.

Also, in the first embodiment, the output image obtained in S808 and the correct image paired with the input image input into the machine learning model in S808 are used in the calculation of the evaluation value in S809. In the present embodiment, the probability obtained in S808 and the probability paired with the input image input into the machine learning model in S808 are used in the calculation of the evaluation value in S809.

### <<Training Data Creation Screen>

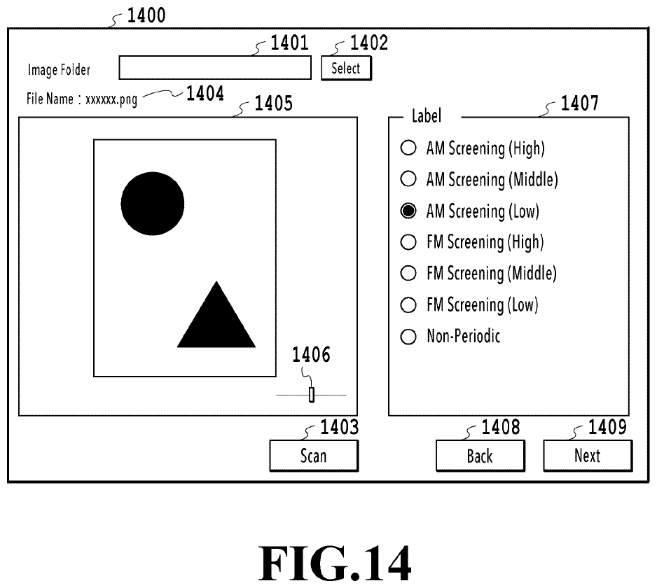

FIG. 14 is a diagram illustrating an example of a training data creation screen 1400. The training data creation screen 1400 is a screen for creating training data. This training data creation screen 1400 is displayed by the learning apparatus 310.

For example, in response to receiving an instruction to launch an executable file, the learning apparatus 310 displays the training data creation screen 1400, which is a user interface, on the display included in the learning apparatus 310. The executable file is stored in a storage device accessible by the learning apparatus 310. Note that the executable file is not limited to one which directly displays the training data creation screen 1400 in response to being launched. For example, an executable file may be employed which displays a launcher screen in response to being launched, and displays the training data creation screen 1400 in a case where an item for creating training data provided in that launcher screen is selected. This makes it possible to switch between the learning setting screen 700 and the training data creation screen 1400.

The training data creation screen 1400 is provided with a path box 1401 and a select button 1402. The path box 1401 is a text box for designating a folder path for image data to be labeled. The image data to be labeled means image data to which to attach information indicating a correct answer (classification label). The select button 1402 is a button for selecting the image data to be labeled. In a case where the user presses the select button 1402, a selection dialogue is displayed on the display, and the user selects (designates) a folder in the selection dialogue, in response to which the folder path to that folder is set in the path box 1401.

The training data creation screen 1400 is provided with a scan button 1403, an image file name 1404, and an image region 1405. The scan button 1403 is a button for reading a printed product with the reading apparatus 100. In response to a press on the scan button 1403, image data of the printed product read by the reading apparatus 100 is saved to the folder designated in the path box 1401. Also, the file name of the image data of the printed product read by the reading apparatus 100 is displayed as the image file name 1404. Also, the image of the image data of the printed product read by the reading apparatus 100 is displayed in the image region 1405 with a zoom bar 1406. The zoom bar 1406 is a slide bar for adjusting the magnification and reduction of the image displayed in the image region 1405.

Also, the training data creation screen 1400 is provided with a label region 1407 for setting a classification label for the image displayed in the image region 1405 (the image of the printed product read by the reading apparatus 100). In the example of FIG. 14, radio buttons corresponding respectively to the above-described seven classifications are disposed. The user may press one desired radio button to set the classification label for the image displayed in the image region 1405. The set (pressed) radio button becomes turned on, while the other radio buttons are turned off.

Also, the training data creation screen 1400 is provided with a button 1408 for returning to an image of a printed product read last time by the reading apparatus 100. Also, the training data creation screen 1400 is provided with a button 1409 for reading a printed product to be read next by the reading apparatus 100.

### <<Training Data Creation Process>>

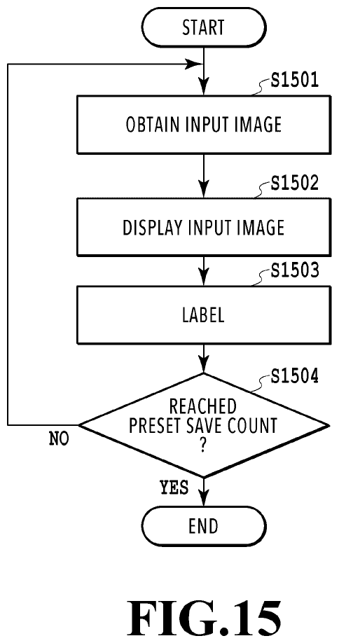

FIG. 15 is a flowchart illustrating an example of a training data creation process using the training data creation screen 1400. The series of processes illustrated in the flowchart of FIG. 15 (training data creation process) is executed in the present embodiment. In the present embodiment, in response to a press on the scan button 1403, the learning apparatus 310 accepts a training data creation instruction and starts the training data creation process.

In S1501, the learning apparatus 310 obtains an input image. Specifically, the learning apparatus 310 requests the reading apparatus 100 to perform low-resolution reading. In response to receiving the low-resolution reading request from the learning apparatus 310, the reading apparatus 100 generates a low-resolution image and transmits it to the learning apparatus 310. The learning apparatus 310 obtains the low-resolution image transmitted as a response to the reading request from the reading apparatus 100 as an input image to be used in a learning process. After the input image is obtained, the process proceeds to S1502.

In S1502, the learning apparatus 310 displays the input image obtained in S1501 in the image region 1405 with the zoom bar 1406, and displays the file name of the obtained input image as the image file name 1404. Also, the learning apparatus 310 saves the input image obtained in S1501 to the folder designated in the path box 1401. Thereafter, the process proceeds to S1503.

In S1503, the learning apparatus 310 performs labeling. Specifically, in response to the user setting a classification label in the label region 1407, the learning apparatus 310 saves the set classification label in association with the input image obtained in S1501. Note that, in a case where a classification label is not set for the input image within a predetermined time after the input image is obtained in S1501, the learning apparatus 310 may display a message prompting the user to set a classification label or the like. After the classification label is saved, the process proceeds to S1504.

In S1504, the learning apparatus 310 judges whether the number of input image has reached a preset save count. The preset save count is the number of images to be saved in the folder designated in the path box 1401. The preset save count may be fixed or designated by the user's operation. If judging in S1504 that the number of input images has not reached the preset save count, the learning apparatus 310 returns to S1501 and, if judging in that the number of input images has reached the preset save count, terminates the series of processes illustrated in the flowchart of FIG. 15, or the training data creation process. Note that, before terminating the training data creation process, the learning apparatus 310 may display a message for notifying that the labeling of input images of the preset save count has been finished.

### <Moire Correction Process>

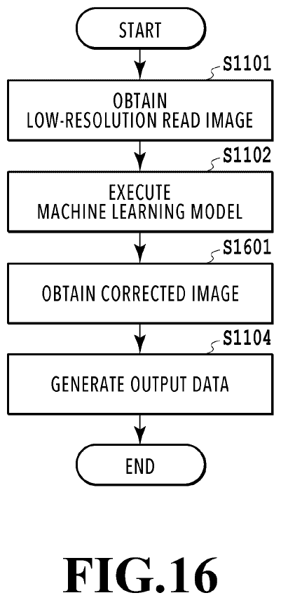

FIG. 16 is a flowchart illustrating an example of a moire correction process in the present embodiment. In the moire correction process in the present embodiment, the process of S1103 illustrated in the flowchart of FIG. 11 is replaced with the process of S1601.

In the present embodiment, the probabilities of the read image of the document obtained in S1101 belonging to the respective seven classification labels are output as the result of the process executed by the machine learning model in S1102.

In S1601, in response to obtaining each probability transmitted from the learning apparatus 310, the CPU 301 causes the image processing unit 304 to execute a correction process for reducing moire. Specifically, the CPU 301 outputs the classification label with the highest probability among the probabilities obtained from the learning device 310 to the image processing unit 304 along with a moire correction request. In this case, the image processing unit 304 performs the correction process for reducing moire on the read image of the document obtained in S1101 by using the classification label.

The correction process for reducing moire is, for example, a blurring process that changes smoothness of the read image of the document obtained in S1101 by using one of the coefficients of filters corresponding respectively to the plurality of classification labels. A coefficient F(x,y) of the Gaussian filter used in this blurring process can be derived with Equation (1) below.

$$F ( x , y ) = \frac{1}{2 {πσ}^{2}} exp ( - \frac{{x}^{2} + {y}^{2}}{2 {σ}^{2}} ) \qquad ( 1 )$$

Reference sign x in Equation (1) represents the distance in the x-axis direction from the central position of the filter. Reference sign y in Equation (1) represents the distance in the y-axis direction from the central position of the filter. Reference sign σ in Equation (1) represents a parameter that determines the coefficient. The smaller σ is, the smaller the smoothness of the image will be.

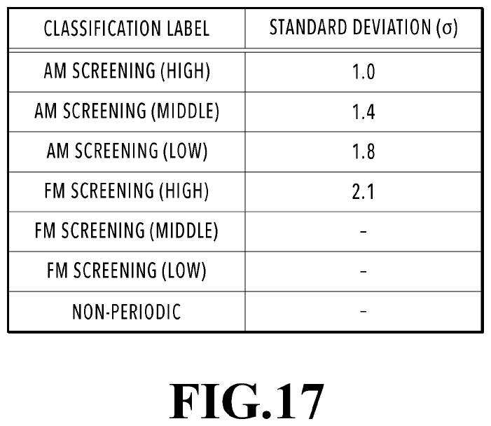

FIG. 17 is a table listing the parameter σ for the coefficient for each classification label. This table is stored in a storage device accessible by the image processing unit 304, such as the ROM 302. In the example of FIG. 17, the parameter σ in a case where the dot period for the classification label is a second period shorter than a first period (i.e., higher frequency) is smaller than the parameter σ in a case where the dot period for the classification label is the first period. The image processing unit 304 performs the blurring process using such a filter that the higher the frequency represented by the dot period for the classification label with the highest probability, the smaller the smoothness of the image will be. That is, in a case where the dot period for the classification label with the highest probability is a second period shorter than a first period (i.e., higher frequency), the image processing unit 304 generates an image with a lower degree of smoothness (less blurring effect) than that in a case where the dot period is the first period.

Note that, in the example of FIG. 17, each classification label with σ set to “-” means that no blurring process is performed. Specifically, in a case where the classification label is “FM SCREENING (MIDDLE),” “FM SCREENING (LOW),” or “NON-PERIODIC,” no blurring process is performed. This is because moire originating from the dot period will not be easily visually recognizable to the user in a case where the classification label is “FM SCREENING (MIDDLE)” or “FM SCREENING (LOW),” and because no moire will occur in a case where the dot period is not periodic. Note that, in a case where a blurring process is performed with the classification label being “FM SCREENING (MIDDLE),” “FM SCREENING (LOW),” or “NON-PERIODIC,” the result of the blurring process tends to be not easily visually recognizable to the user.

The CPU 301 causes the image processing unit 304 to execute the correction process for reducing moire, and obtains the read image subjected to the correction process as a corrected image. After the corrected image is obtained, the process proceeds to S1104.

As described above, according to the present embodiment, it is possible to appropriately reduce moire even in a case where the printing resolution, the quantization algorithm, and the like are different, as in the first embodiment. For example, the reading apparatus 100 performs a blurring process using a coefficient corresponding to a classification label with the highest probability. In this way, it is possible to apply an appropriate degree of smoothness (blurring effect) to the read image of the document based on the regularity between input images and moire learned by machine learning. Also, it is possible to implement effective moire reduction while avoiding unexpected trouble due to the machine learning. Specifically, while the printing resolution and the like are estimated by referring to a wide range using a CNN model, the correction process for reducing moire is performed by a filtering process. This is advantageous because the estimation by the CNN model will not lead to severe image degradation even in a case where the estimation is not favorable.

Note that, in the present embodiment, the printing method and the dot period are classified into seven classification labels, but the classification labels are not limited to these. For example, the angle of halftone dots in AM screening (the angle of dot patterns) may be classified as one classification label. Alternatively, the method of dithering in FM screening may be classified as one classification label. Alternatively, the dot diameter, the order in which the colors overlap, and the like may each be classified as one classification label. In a case where the dot diameter and the order in which the colors overlap are classified as classification labels, a more precise moire correction process can be used for the cause of the moire.

Also, the correction process for reducing moire is not limited to the blurring process using a blurring filter. For example, the correction process for reducing moire may be a process that performs low-pass filtering or high-pass filtering on the frequency component by discrete Fourier transform.

Also, in the present embodiment, the moire correction process, the learning process, and the estimation process are each performed on the entire image, but the image may be divided into a plurality of regions and the processes may be performed on each of the regions. In that case, the learning process is performed for each of the plurality of regions, and the sets of learned parameters corresponding to the respective regions are stored in the ROM 302. The reading apparatus 100 causes a machine learning model to execute a process using the learned parameters corresponding to a selected region. In this way, in a case where there is a region that is not part of a printed product, such as in a case where there is a handwritten note on a marginal portion of the sheet, for example, it is possible to omit unnecessary blur filtering and maintain sharpness.

Also, a machine learning model which, instead of learning printing methods, estimates the coefficient to be used in the blurring process (parameter σ) may be used. This machine learning model can be implemented by configuring the final layer of the machine learning model such that it has a number of dimensions corresponding to the number of parameters and serves as a regression-classification model. In a case where a machine learning model that estimates the parameters to be used in the blurring process is used, it is possible to perform a blurring process suitable for the input printed product's characteristics even if the printing resolution of the printed product has not been learned and is unknown.

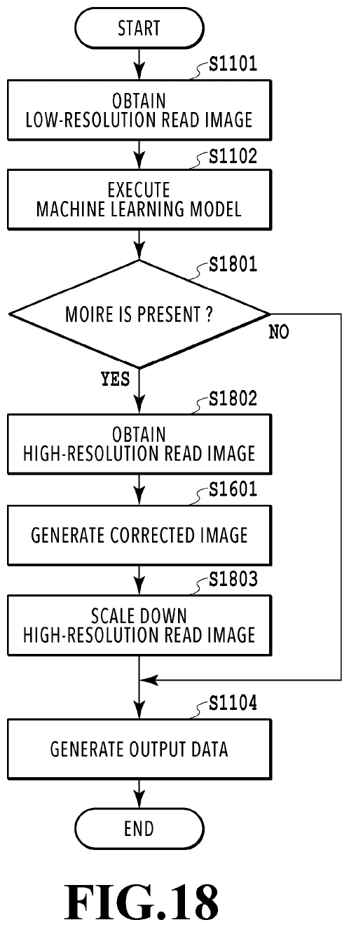

Also, as another approach, a machine learning model that additionally judges whether moire is present may be used. This can be implemented by further adding a classification label indicating whether moire is present in the image, and training a CNN model that performs an additional classification at the final layer. FIG. 18 is a flowchart illustrating an example of a moire correction process in another embodiment. In this moire correction process, the process of S1801 and the process of S1802 are added between the process of S1102 and the process of S1601 illustrated in the flowchart of FIG. 16. Also, the process of S1803 is added between the process of S1601 and the process of S1104 illustrated in the flowchart of FIG. 16.

In S1801, the CPU 301 judges whether moire is present in the low-resolution read image obtained in S1101. Specifically, the CPU 301 causes a machine learning model to execute a process, and obtains the probabilities of belonging to the respective classification labels output from the machine learning model as the result of that process. Also, the CPU 301 compares each of the probabilities of belonging the respective classification labels for judging whether moire is present with a threshold value. If this probability is less than the threshold value, the CPU 301 judges in S1801 that moire is not present, and proceeds to S1104. If, on the other hand, this probability is more than or equal to the threshold value, the CPU 301 judges in S1801 that moire is present, and proceeds to S1802.

In S1802, the CPU 301 reads the document placed on the document plate 102 again to obtain a high-resolution read image. Specifically, the CPU 301 controls the drive unit 307 to cause the reading unit 103 to read the document placed on the document plate 102. Then, the CPU 301 controls the scanning unit 305 to generate image data corresponding to the high-resolution color scan mode based on a signal output from the reading unit 103. Then, the CPU 301 controls the image processing unit 304 to cause the image processing unit 304 to execute the image processing illustrated in FIG. 4. The image data subjected to this image processing is the high-resolution read image.

After the high-resolution read image is obtained, the process proceeds to S1601. In S1601, the CPU 301 causes the image processing unit 304 to perform a correction process for reducing moire on the high-resolution read image obtained in S1802. Thereafter, the process proceeds to S1803.

In S1803, the CPU 301 causes the image processing unit 304 to scale down the high-resolution read image subjected to the moire correction. Specifically, the CPU 301 causes the image processing unit 304 to scale down the high-resolution read image to make the read image equal in resolution to the low-resolution read image obtained in S1101. The read image thus scaled down is the data of the corrected image mentioned earlier.

As described above, by scaling down the high-resolution read image after the read image is subjected to a blurring process, it is possible to reduce moire more effectively than in a case of performing a blurring process on the low-resolution read image obtained in S1101.

### OTHER EMBODIMENTS

In the above-described embodiments, the reading apparatus 100 is a single-function scanner including only the scanning unit 305, but the present disclosure is not limited to this. For example, the reading apparatus 100 may be a copying apparatus including the scanning unit 305 and a unit other than the scanning unit 305. The copying apparatus is also called a multifunction peripheral (MFP).

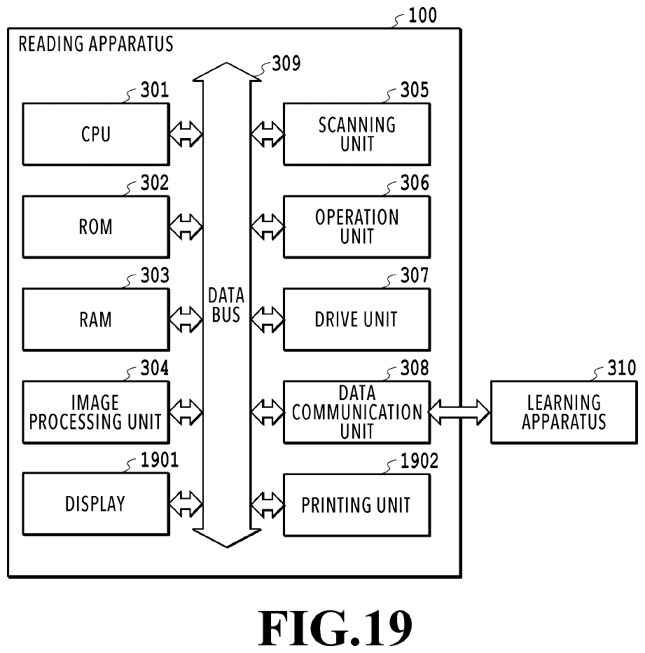

FIG. 19 is a block diagram illustrating an example of a configuration of the reading apparatus 100 in a case where it is a copying apparatus. The copying apparatus further includes a touch display 1901 and a printing unit 1902 in addition to the configuration of the reading apparatus 100 described above. The touch display 1901 has a liquid crystal layer and a touch sensor layer. The touch display 1901 is capable of displaying images such as read images, user interface screens, and the like. Also, the touch display 1901 is capable of accepting various pieces of information in response to the user's operations on the user interface screens. The printing unit 1902 is a unit capable of printing images and the like.

Including the touch display 1901 makes it possible to execute a scan mode with software keys on a user interface screen without a button included in the operation part 104 (hardware key). Note that the touch display 1901 may be included in the reading apparatus 100 in the above-described embodiments (single-function scanner).

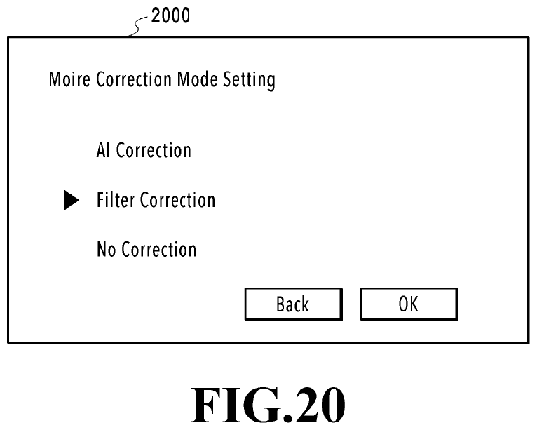

Also, in the above-described embodiments, the reading apparatus 100 does not switch between an image generation model and a classification model, but the present disclosure is not limited to this. For example, the reading apparatus 100 may be capable of switching between an image generation model and a classification model according to the user's operation. An example in which the reading apparatus 100 is capable of switching between an image generation model and a classification model according to the user's operation will be described below using FIG. 20.

FIG. 20 is a diagram illustrating an example of a UI screen 2000 for correction modes. The UI screen 2000 is displayed on a display of an information terminal connected to the reading apparatus 100 through the data communication unit 308, for example. The information terminal may be a personal computer, a smartphone, or the like. In a case where the reading apparatus 100 includes the touch display 1901, the UI screen 2000 may be displayed on the touch display 1901.

Also, the UI screen 2000 is displayed by the CPU 301. The CPU 301 displays the UI screen 2000, for example, in a case where “Moire Correction Method” is selected from among setting items in a top screen (not illustrated) displayed on the touch display 1901 or the like.

On the UI screen 2000, “AI Correction” as a first correction mode, “Filter Correction” as a second correction mode, or “No Correction” as a third correction mode can be set. The user can set a desired correction mode by selecting the correction mode and pressing the OK button.

In a case where “AI Correction” is set, the CPU 301 executes the moire correction process illustrated in the flowchart of FIG. 11. In a case where “Filter Correction” is set, the CPU 301 executes the moire correction process illustrated in the flowchart of FIG. 16. In a case where “No Correction” is set, the CPU 301 performs no moire correction process.

As described above, the CPU 301 can switch between an image generation model and a classification model according to the user's operation.

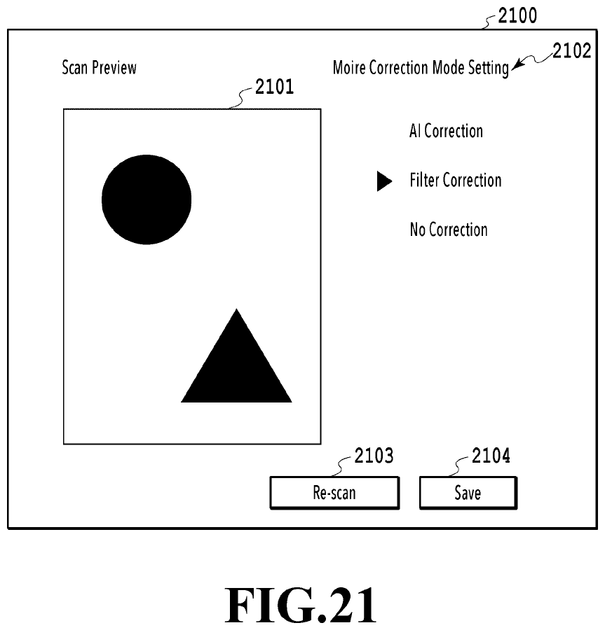

Also, in the above-described embodiments, the reading apparatus 100 does not display the result of the moire correction process, but the present disclosure is not limited to this. The reading apparatus 100 may display the result of the moire correction process. FIG. 21 is a diagram illustrating an example of a preview screen 2100. In the example of FIG. 21, the reading apparatus 100 is capable of switching between an image generation model and a classification model according to the user's operation.

The preview screen 2100 is displayed on a display of an information terminal connected to the reading apparatus 100 through the data communication unit 308, for example. In a case where the reading apparatus 100 includes the touch display 1901, the preview screen 2100 may be displayed on the touch display 1901.

Also, the preview screen 2100 is displayed by the CPU 301 after the moire correction process. For example, the CPU 301 displays the preview screen 2100 in response to accepting a preview instruction from the operation part 104 based on the user's operation, or after terminating the moire correction process regardless of whether the user's operation is given or not.

The preview screen 2100 is provided with a preview region 2101 and a correction mode setting item 2102. In the preview region 2101, the read image subjected to the moire correction process is displayed. As the correction mode setting item 2102, the correction mode used for the read image displayed in the preview region 2101 is set. The user can change the correction mode set as the correction mode setting item 2102.

In a case where the correction mode is changed, the CPU 301 executes the moire correction process corresponding to the changed correction mode, and displays its result in the preview region 2101 instead of the current display. That is, each time the correction mode is switched, the CPU 301 performs control to display an image corresponding to the correction mode. For example, in a case where the correction mode is switched to “AI Correction,” the result of the moire correction process illustrated in the flowchart of FIG. 11 is displayed in the preview region 2101. Also, in a case where the correction mode is switched to “Filter Correction,” the result of the moire correction process illustrated in the flowchart of FIG. 16 is displayed in the preview region 2101. Also, in a case where the correction mode is switched to “No Correction,” the read image obtained in S1101 is displayed in the preview region 2101. Note that in the case of displaying an image in the preview region 2101, the process of S1104 does not need to be executed.

Also, the preview screen 2100 is provided with a re-scan button 2103 and a save button 2104. The re-scan button 2103 is a button for starting the moire correction process. The save button 2104 is a button for saving the output data obtained by the moire correction process.

As described above, each time the correction mode is switched, the CPU 301 performs control to display an image corresponding to the correction mode. In this way, the user can save the read image subjected to the moire correction corresponding to an appropriate correction mode while checking the result of the moire correction.

Note that, in the case where the reading apparatus 100 includes the printing unit 1902, the read image subjected to the moire correction can be printed. This makes it possible to implement a copying process with reduced moire.

In the above-described embodiments, the learning apparatus 310, which is external to the reading apparatus 100, is caused to execute a machine learning model's process, but the present disclosure is not limited to this. A machine learning model's process may be executed in the reading apparatus 100. For example, the image processing unit 304 causes a machine learning model to execute a process. In this case, the machine learning model may be stored in the ROM 302 or obtained from the learning apparatus 310.

In the above-described embodiments, CNN models are employed as machine learning models, but the present disclosure is not limited to this. For example, support vector machine (SVM) models may be employed as machine learning models.

Alternatively, linear regression models may be employed as machine learning models. Alternatively, polynomial regression models may be employed as machine learning models. Note that the model parameters of the CNN models include a weight and a bias. The model parameters of the SVM models include a regularization parameter. The model parameters of the linear regression models include a slope and an intercept. The model parameters of the polynomial regression models include the coefficients of non-linear functions called basis functions. Note that the model parameters of the CNN models (image generation models or classification models) may include a model structure in addition to the weight and the bias. The model structure is information indicating the structure of the model such as the types and number of layers, as described earlier.

In the above-described embodiments, the CPU 301 of the reading apparatus 100 loads and obtains learned parameters stored in the ROM 302 in the reading apparatus 100, but the present disclosure is not limited to this. The CPU 301 of the reading apparatus 100 may load and obtain learned parameters stored outside the reading apparatus 100.

In the above-described embodiments, the reading apparatus 100 executes the moire correction process, but the present disclosure is not limited to this. For example, an image processing apparatus connected to the reading apparatus 100 through a network or the like may execute the moire correction process on the read image read by the reading apparatus 100. In this case, the image processing apparatus supplies the read image obtained by performing the moire correction process to the reading apparatus 100.

In the above-described embodiments, as an input image of a printed product printed with a dot period, an image of the printed product actually read by the reading apparatus 100 is used, but the present disclosure is not limited to this. For example, as an input image of a printed product printed with a dot period, a simulated image of the printed product printed with the dot period may be used. Alternatively, as an input image of a printed product printed with a dot period, a document file, such as a Portable Document Format (PDF), Word, or PowerPoint file, may be used.

The present disclosure is aimed at reducing moire that occurs as a result of reading the dot period of a printed product. Thus, image data obtained by performing color conversion and quantization in similar methods to those in a case of printing a document file can be used in place of image data obtained by actually reading the printed product. In that case, blur, noise, and the like that would appear due to printing and reading may be simulated and added to the image data. In this way, a learning process using a large amount of training data can be performed easily. Also, a learning process may be performed with a combination of a large amount of simulated image data thus created and a small amount of real image data obtained by actually reading printed products. Alternatively, a learning process may be performed using the simulated image data, and then a learning process may be additionally performed using real image data. In this way, an effective moire correction process can be implemented with a small amount of real image data.

Also, while the present disclosure has been described in detail based on its preferred embodiments, the present disclosure is not limited to these specific embodiments and encompasses various forms without departing from the gist of this disclosure. Further, each of the above embodiments is merely one embodiment of the present disclosure, and the embodiments can be combined as appropriate.

Also, the various processes described above as processes to be performed by the CPU 301 may be performed by a single piece of hardware, or the processes may be shared and performed by a plurality of pieces of hardware (e.g., a plurality of processors or circuits). For example, at least part of the CPU 301 that functions as the reading unit, first obtaining unit, model execution unit, second obtaining unit, setting unit, and display control unit described below or the like may be configured of hardware.

Also, the various processes described above as processes to be performed by the learning apparatus 310 may be performed by a single piece of hardware, or the processes may be shared and performed by a plurality of pieces of hardware (e.g., a plurality of processors or circuits). For example, at least part of the learning apparatus 310 that functions as the learning unit and storage control unit described or the like may be configured of hardware.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

According to the present disclosure, moire can be reduced appropriately.

This application claims the benefit of Japanese Patent Application No. 2025-020841, filed Feb. 12, 2025, which is hereby incorporated by reference herein in its entirety.

What is claimed is:

1. A reading apparatus comprising:
one or more memories storing instructions; and
one or more processors which function as:
a reading unit configured to be capable of reading a document;
a first obtaining unit configured to obtain a learned parameter which is a model parameter of a machine learning model learned with an input image of a printed product printed with a dot period as an input;
a model execution unit configured to cause the machine learning model to perform a process using the learned parameter with a read image of the document obtained based on reading by the reading unit as an input; and
a second obtaining unit configured to obtain a corrected image subjected to a correction process for reducing an unintended pattern that appears due to the dot period by using a result of the process executed by the model execution unit.

2. The reading apparatus according to claim 1, wherein the dot period includes one of a printing resolution of a printing apparatus which printed the document and a quantized pattern.

3. The reading apparatus according to claim 1, wherein
the machine learning model is an image generation model which generates an image by performing a calculation corresponding to the correction process, and
the second obtaining unit obtains the image output from the image generation model as the corrected image.

4. The reading apparatus according to claim 1, wherein the first obtaining unit obtains, from among the learned parameters corresponding respectively to a plurality of reading resolutions, the learned parameter corresponding to a selected one of the reading resolutions.

5. The reading apparatus according to claim 1, wherein
the machine learning model is a classification model which classifies the dot period, and
the second obtaining unit performs the correction process on the read image using a probability of each of a plurality of classification labels output from the classification model.

6. The reading apparatus according to claim 5, wherein the plurality of classification labels include at least one of a dot interval, a dot diameter, an order in which colors overlap, an angle of a dot pattern, and a size of a filter mask.

7. The reading apparatus according to claim 5, wherein the first obtaining unit obtains, from among the learned parameters corresponding respectively to a plurality of regions in an image, the learned parameter corresponding to a selected one of the regions.

8. The reading apparatus according to claim 5, wherein
one of the plurality of classification labels is a classification label on whether the unintended pattern is present, and
the second obtaining unit performs the correction process in a case where the probability of the classification label on whether the unintended pattern is present is more than or equal to a threshold value.

9. The reading apparatus according to claim 5, wherein the second obtaining unit performs the correction process on the read image with a second resolution higher than a first resolution, and then scales down the read image subjected to the correction process such that the read image has the first resolution.

10. The reading apparatus according to claim 1, further comprising a setting unit configured to set one of a plurality of correction modes, wherein
the model execution unit causes, among the machine learning models corresponding respectively to the plurality of correction modes, the machine learning model corresponding to the correction mode set by the setting unit to execute a process.

11. The reading apparatus according to claim 10, wherein the machine learning models corresponding respectively to the plurality of correction modes include an image generation model and a classification model.

12. The reading apparatus according to claim 10, further comprising a display control unit configured to perform control to display an image, wherein
each time the correction mode set by the setting unit is switched, the display control unit performs control to display an image corresponding to the correction mode.

13. The reading apparatus according to claim 1, wherein
the reading unit is capable of switching between a first scan mode in which the reading unit performs reading with a first resolution and a second scan mode in which the reading unit performs reading with a second resolution higher than the first resolution, and
the first obtaining unit obtains the learned parameter in the case that the first scan mode is performed, and does not obtain the learned parameter in the case that the second scan mode is performed.

14. A reading method comprising:
reading a document;
causing a machine learning model to execute a process with a read image of the document as an input by using a learned parameter which is a model parameter of the machine learning model learned with an input image of a printed product printed with a dot period as an input; and
obtaining a corrected image subjected to a correction process for reducing an unintended pattern that appears due to the dot period by using a result of the executed process.

15. A non-transitory computer readable storage medium storing a program for causing a computer to perform a reading method, the reading method comprising:
reading a document;
causing a machine learning model to execute a process with a read image of the document as an input by using a learned parameter which is a model parameter of the machine learning model learned with an input image of a printed product printed with a dot period as an input; and
obtaining a corrected image subjected to a correction process for reducing an unintended pattern that appears due to the dot period by using a result of the executed process.
